(19) United States
(12) Patent Application Publication
(10) Pub. No.: US 2011/0064641 A1
(43) Pub. Date: Mar. 17, 2011

(54) AMMONIA GENERATING METHOD AND APPARATUS THEREFOR

(75) Inventor: Masaki Iijima, Minato-ku, Tokyo (JP)

(73) Assignee: MITSUBISHI HEAVY INDUSTRIES, LTD., Tokyo (JP)

(21) Appl. No.: 12/726,735

(22) Filed: Mar. 18, 2010

(30) Foreign Application Priority Data
Sep. 16, 2009 (JP) 2009-214356

(51) Int. Cl. C01C 1/04; C01C 1/00

(52) U.S. Cl. 423/359; 422/148

(57) ABSTRACT

An object of the present invention is to provide an ammonia generating method and apparatus that can be operated continuously for a long period of time, and that reduces the cost.

The present invention has a gasification furnace 2 into which coal and air are introduced, constituted to perform partial oxidation to gasify the coal; a desulfurizing apparatus 3 constituted to desulfurize the gas generated by the gasification furnace 2; a shift reactor 4 constituted to convert carbon monoxide present in the gas exhausted from the desulfurizing apparatus 3 to carbon dioxide; a carbon dioxide scrubber 5 constituted to remove carbon dioxide present in the gas exhausted from the shift reactor 4; a denitrification apparatus 6 constituted so that, by removing nitrogen present in the gas exhausted from the carbon dioxide scrubber 5, the molar ratio between nitrogen and hydrogen present in the gas is adjusted to approximately 1:3; and an ammonia generator 7 that generates ammonia by causing a reaction between the nitrogen and hydrogen present in the gas exhausted from the denitrification apparatus 6.

### BACKGROUND OF THE INVENTION

The present invention relates to an ammonia generating method, and in particular, relates to a method and apparatus for generating ammonia from coal.

### BACKGROUND ART

In recent years, various plants have been constructed for the purpose of making ammonia, a typical type thereof being one that makes ammonia from coal. In the past, when synthesizing ammonia from coal, oxygen is first used to gasify the coal, thereby generating carbon monoxide (CO) and hydrogen gas and the like. After that, the carbon monoxide is converted to hydrogen gas and carbon dioxide by using a CO shift reaction. Then finally, nitrogen is introduced to the hydrogen gas, and the Haber-Bosch process is used to generate ammonia from the nitrogen and hydrogen.

Japanese Laid-Open Patent Application Publication 60-11587 (Patent Document 1) discloses a gasification method for making ammonia in the past. In Patent Document 1, an air separator is used to supply oxygen to a gasification apparatus when coal or coke is gasified.

### SUMMARY OF THE INVENTION

However, if oxygen is used when performing gasification of coal as described above in the conventional art, the oxygen concentration when the coal is partially oxidized is high, causing the gasification reaction in a gasification furnace to reach a high temperature. The result of this is that the refractory brick in the gasification furnace reaches the end of its service life early, making it difficult to use the gasification furnace continuously for a long period of time. Additionally, when the gasification reaction in the gasification furnace reaches a high temperature, ashes and the like generated in the processing of the coal melt and adhere to the walls of the gasification furnace, thereby creating the problem of hindering operation.

Also, in a constitution in which oxygen is used in the gasification of coal, it is necessary to have equipment for supplying oxygen to the gasification furnace, leading to the problem of high cost for the overall apparatus.

The present invention was made in consideration of the above-noted circumstances, and has as an object to provide an ammonia generating method and apparatus that not only can be operated continuously for a long period of time, but that also reduces the cost.

To solve the problems in the above-described convention art, an aspect of the present invention provides an ammonia generating apparatus having a gasification furnace into which coal and air are introduced, constituted so as to perform partial oxidation to gasify the coal, a desulfurizing apparatus constituted so as to desulfurize the gas generated by the gasification furnace, a shift reactor constituted so as to convert carbon monoxide present in the gas exhausted from the desulfurizing apparatus to carbon dioxide, a carbon dioxide scrubber constituted so as to remove carbon dioxide present in the gas exhausted from the shift reactor, a denitrification apparatus constituted so that, by removing nitrogen present in the gas exhausted from the carbon dioxide scrubber, the molar ratio between nitrogen and hydrogen present in the gas is adjusted to approximately 1:3, and an ammonia generator that generates ammonia by causing a reaction between the nitrogen and hydrogen present in the gas exhausted from the denitrification apparatus.

Additionally, according to another aspect of the present invention, the denitrification apparatus is constituted so as to remove nitrogen by using a gas-separating membrane.

According to yet another aspect of the present invention, the denitrification apparatus is constituted so as to remove nitrogen by using an adsorbing material.

To solve the problems in the above-described conventional art, another aspect of the present invention provides an ammonia generating method including a step of gasifying coal by introducing coal and air and causing partial oxidation, a step of desulfurizing the gas generated by the gasification step, a step of converting carbon monoxide present in the gas to carbon dioxide, a step of removing carbon dioxide present in the gas, a step of adjusting the molar ratio between nitrogen and hydrogen present in the gas to approximately 1:3 by removing nitrogen present in the gas, and a step of generating ammonia by causing a reaction between nitrogen and hydrogen present in the gas.

According to another aspect of the present invention, the adjusting step removes the nitrogen by using a gas-separating membrane.

According to yet another aspect of the present invention, the adjusting step removes the nitrogen by using an adsorbing material.

### EFFECTS OF THE INVENTION

Because an ammonia generating apparatus of the present invention has a gasification furnace into which coal and air are introduced, constituted so as to perform partial oxidation to gasify the coal, a desulfurizing apparatus constituted so as to desulfurize the gas generated by the gasification furnace, a shift reactor constituted so as to convert carbon monoxide present in the gas exhausted from the desulfurizing apparatus to carbon dioxide, a carbon dioxide scrubber constituted so as to remove carbon dioxide present in the gas exhausted from the shift reactor, a denitrification apparatus constituted so that by removing nitrogen present in the gas exhausted from the carbon dioxide scrubber, the molar ratio between nitrogen and hydrogen present in the gas is adjusted to approximately 1:3, and an ammonia generator that generates ammonia by causing a reaction between the nitrogen and hydrogen present in the gas exhausted from the denitrification apparatus, the oxygen concentration when the coal is combusted is reduced and, compared to the case of using oxygen to gasify coal, the temperature of the gasification reaction in the gasification furnace is low. As a result, it is possible to extend the life of the refractory brick inside the gasification furnace. Also, there is no melting of ashes and the like generated in the processing of the coal and adhesion thereof to the walls of the gasification furnace, so that operation of the gasification furnace is not hindered. The result is that, according to the present invention, it is possible to operate the gasification furnace continuously for a long period of time.

Also, because air is used to gasify the coal, the nitrogen present in the air can be used in the subsequent generation of ammonia, without introduction of nitrogen into the gas as was conventionally done.

Additionally, although in the past oxygen was used to gasify coal, thereby necessitating oxygen generating plant equipment for supplying oxygen, with the present invention because air is used to gasify coal, the need to provide oxygen generating plant equipment is eliminated, thereby enabling a reduction in the overall cost of the apparatus.

According to an ammonia generating apparatus of the present invention, because the denitrification apparatus may be constituted so as to remove nitrogen using a gas-separating membrane, it is possible to use the difference in permeating speed in the gas-separating membrane between nitrogen and hydrogen to separate nitrogen and hydrogen so as to adjust the molar ratio between nitrogen and hydrogen. Also, because the constitution makes use of a membrane, it is possible to achieve a simpler constitution for the apparatus. Also, in this constitution because there is a reduction of the pressure of the nitrogen and the hydrogen that pass through the gas-separating membrane, it is necessary to raise the pressure when generating ammonia.

According to an ammonia generating apparatus of the present invention, because the denitrification apparatus may be constituted so as remove nitrogen using an adsorbing material, it is possible to adjust the molar ratio between nitrogen and hydrogen by removing nitrogen from the gas without a reduction in the pressure of the hydrogen.

Because an ammonia generating method of the present invention includes a step of gasifying coal by introducing coal and air and causing partial oxidation, a step of desulfurizing the gas generated by the gasification step, a step of converting carbon monoxide present in the gas to carbon dioxide, a step of removing carbon dioxide present in the gas, a step of adjusting the molar ratio between nitrogen and hydrogen present in the gas to approximately 1:3 by removing nitrogen present in the gas, and a step of generating ammonia by causing a reaction between nitrogen and hydrogen present in the gas, the oxygen concentration when the coal is combusted is reduced and, compared to the case of using oxygen to gasify coal, the temperature of the gasification reaction in the gasification furnace is low. As a result, it is possible to extend the life of the refractory brick inside the gasification furnace. Also, there is no melting of ashes and the like generated in the processing of the coal and adhesion thereof to the walls of the gasification furnace, so that operation of the gasification furnace is not hindered. The result is that, according to the present invention, it is possible to operate the gasification furnace continuously for a long period of time.

Also, because air blowing is used to gasify the coal, the nitrogen present in the air can be used in the subsequent generation of ammonia, without the introduction of nitrogen into the gas as was conventionally done.

According to an ammonia generating method of the present invention, because the adjusting step may use a gas-separating membrane to remove nitrogen, it is possible to use the difference in permeating speed in the gas-separating membrane between nitrogen and hydrogen to separate the nitrogen and the hydrogen so as to adjust the molar ratio between the nitrogen and the hydrogen. Also, because in this method there is a reduction of the pressure of the nitrogen and the hydrogen that pass through the gas-separating membrane, it is necessary to raise the pressure when generating ammonia.

According to an ammonia generating apparatus of the present invention, because the adjusting step may use an adsorbing material to remove nitrogen, it is possible to adjust the molar ratio between nitrogen and hydrogen by removing the nitrogen from the gas without a reduction in the pressure of the hydrogen.

### BRIEF DESCRIPTIONS OF THE DRAWINGS

FIG. 1 is a block diagram showing in an ammonia generating apparatus according to an embodiment of the present invention.

FIG. 2 is a drawing showing the gas composition after wet-process gas refining and the gas composition after the CO shift reaction.

FIG. 3 is a graph showing the temperature dependency of the gas permeability coefficient of a polyimide membrane.

FIG. 4 is a graph showing the temperature dependency of the gas permeability coefficient of a cellulose acetate membrane.

FIG. 5 is a graph showing the adsorption equilibrium between hydrogen and nitrogen in activated charcoal.

### DETAILED DESCRIPTION OF THE INVENTION

### First Embodiment

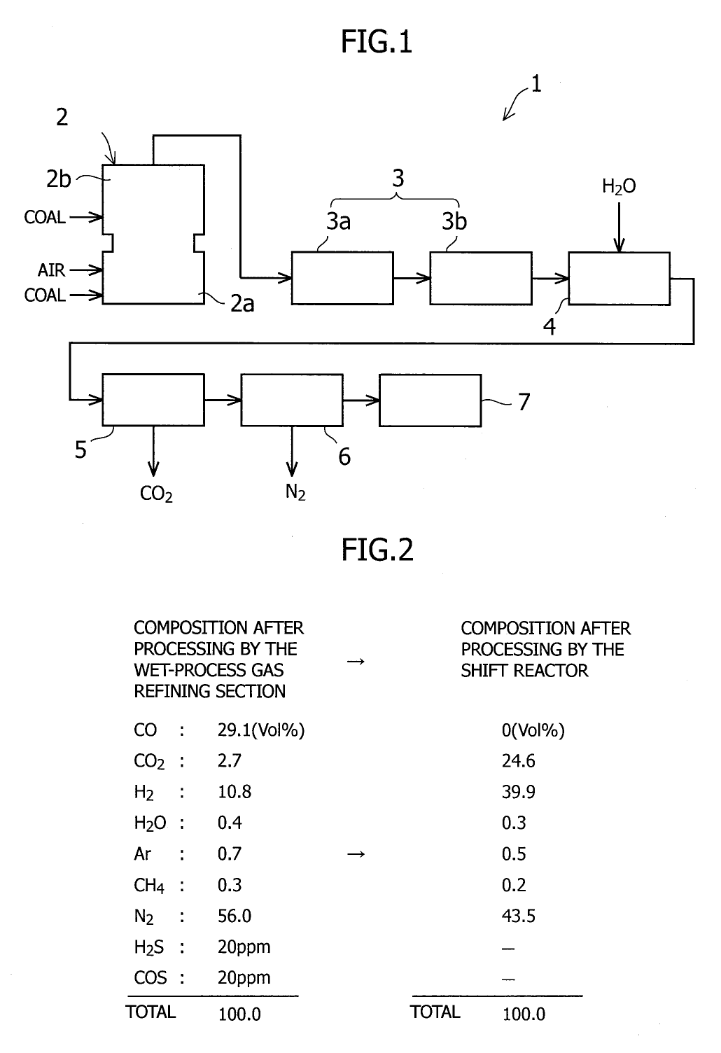

The first embodiment of an ammonia generating apparatus according to the present invention is described below with reference made to the accompanying drawings. FIG. 1 is a block diagram showing an ammonia generating apparatus according to this embodiment of the present invention.

As shown in FIG. 1, the ammonia generating apparatus 1 of this embodiment is provided with a gasification furnace 2, a desulfurizing apparatus 3, a shift reactor 4, a carbon dioxide scrubber 5, a denitrification apparatus 6, and an ammonia generator 7.

The gasification furnace 2 is an air-blowing type of gasification furnace, which is constituted by a combustion chamber (combustor) 2a and a gasification chamber (reductor) 2b. The gasification furnace 2 is arranged so as to combust coal, air and char (not illustrated) that are introduced into the combustion chamber 2a at a high temperature. In addition to introducing more coal into the gasification chamber 2b, the gasification furnace 2 makes use of the high-temperature combustion gas in the combustion chamber 2a to gasify the coal within the gasification chamber 2b.

The desulfurizing apparatus 3 is constituted by a wet-process gas refining section 3a and a dry-process desulfurizing section 3b. The wet-process gas generating section 3a of the desulfurizing apparatus 3 removes the hydrogen sulfide present in the coal gasification gas generated by the gasification furnace 2. It is possible to use the method of using MDEA (methyl diethalonolamine) as the adsorbing liquid in the desulfurizing method. In this method, the hydrogen sulfide is first absorbed by an organic solvent, and hydrogen sulfide (H₂S) is extracted at a point at which the concentration of hydrogen sulfide in the solvent becomes high. The concentrated hydrogen sulfide is oxidized to sulfur dioxide and, using a conventional method used in coal-fired thermoelectric plants, that is, the method of causing it to react with a calcium carbonate slurry, is hardened as gypsum to perform desulfurizing. On the left side of FIG. 2 is shown the composition of the coal gasification gas after processing by the wet-process gas refining section 3a.

The dry-process desulfurizing section 3b of the desulfurizing apparatus 3 removes sulfur by adsorbing hydrogen sulfide present in the coal gasification gas. The adsorption desulfurizing method may be, for example, the dry-process desulfurizing method of adsorbing hydrogen sulfide by microparticles of zinc oxide (ZnO).

The shift reactor 4 is constituted so as to convert the carbon monoxide present in the coal gasification gas exhausted from the desulfurizing apparatus 3 to carbon dioxide. Specifically, the shift reactor 4 is arranged so as to convert carbon monoxide to carbon dioxide by a CO shift reaction. The shift reaction referred to herein is a reaction that is expressed by the formula (1) below, and the shift reactor 4 is arranged to cause a reaction of a gas mixture of carbon monoxide and steam at a high temperature (for example, 350 to 400° C.) in the presence of a catalyst. The catalyst for the CO shift reaction may be a Fe—Cr based oxide or Cu—Zn based oxide or the like.

CO+H₂O<-->CO₂+H₂ (1)

On the right side of FIG. 2 is shown the composition of the gas after processing by the shift reactor 4. As shown in FIG. 2, the gas after processing by the shift reactor 4 has a carbon monoxide concentration (vol %) close to zero.

The carbon dioxide scrubber 5 is constituted to remove carbon dioxide present in the gas processed by the shift reactor 4. The method of removing carbon dioxide may be, for example, the amine method. In this method, an alkanolamine aqueous solution, for example, as the adsorbing liquid, and carbon dioxide is caused to be adsorbed by this adsorbing liquid.

In this embodiment, the denitrification apparatus 6 is constituted so as to adjust the molar ratio between nitrogen and hydrogen in the gas to approximately 1:3 by removing nitrogen in the gas exhausted from the carbon dioxide scrubber 5. Specifically, the denitrification apparatus 6 is constituted so as to remove nitrogen using a gas-separating membrane. A polyimide membrane or a cellulose acetate membrane may be used as the gas-separating membrane. In the description that follows, the examples of using a polyimide membrane or cellulose acetate membrane are used.

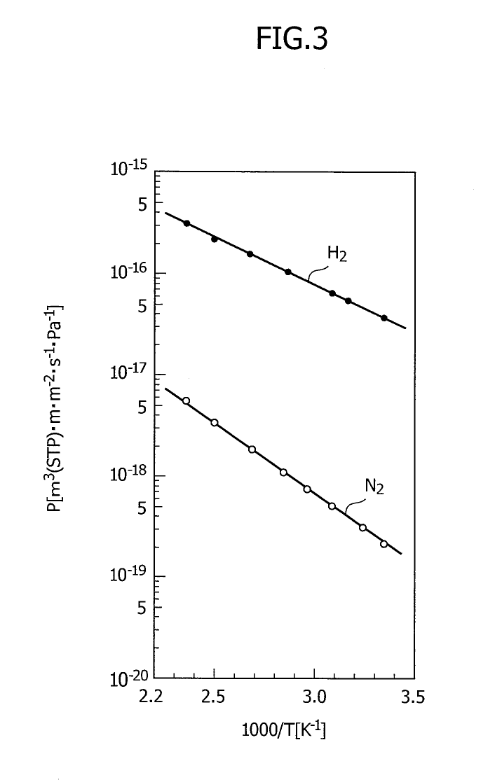

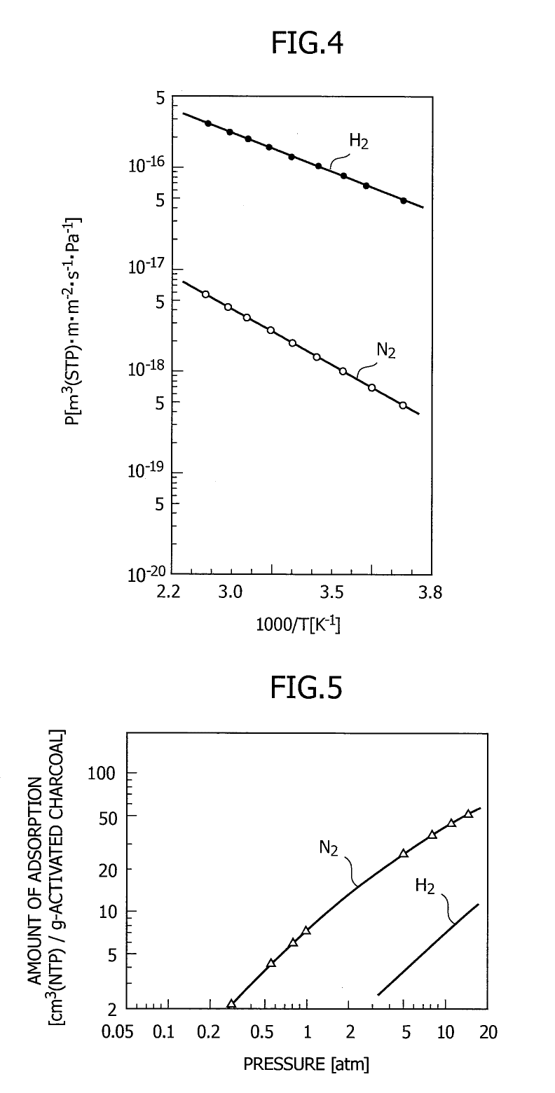

FIG. 3 is a graph showing the temperature dependency of the gas permeability coefficient of a polyimide membrane, this graph showing the change in the permeability coefficient for hydrogen and nitrogen. FIG. 4 is a graph showing the temperature dependency of the gas permeability coefficient of a cellulose acetate membrane, this graph showing the change in the permeability coefficient for hydrogen and nitrogen.

As shown in FIG. 3 and FIG. 4, if hydrogen and nitrogen are compared, the permeability coefficient of hydrogen is higher. Therefore, if a polyimide membrane or a cellulose acetate membrane is used, it is possible to separate nitrogen and hydrogen by the difference in the rate of permeation between nitrogen and hydrogen. In this embodiment, the denitrification apparatus 6 is constituted to use the difference in rate of permeation for nitrogen and hydrogen as shown in FIG. 3 and FIG. 4 to adjust the molar ratio between nitrogen and hydrogen in the gas to approximately 1:3.

The ammonia generator 7 is constituted so as to generate ammonia by causing a reaction between nitrogen and hydrogen present in the gas exhausted from the denitrification apparatus 6. The Haber-Bosch process may be used as the method of generating ammonia. In this method, nitrogen and hydrogen are mixed with a molar ratio of 1-3 and ammonia is generated at a temperature of 450 to 550° C. and at a pressure of 150 to 1000 atmospheres in the presence of a catalyst in which alumina or the like has been added to the main component of magnetite (Fe₃O₄), in accordance with the following formula (2).

N₂+3N₂->2NH₃ (2)

Next, the flow in an ammonia generating method according to an embodiment of the present invention will be described, using FIG. 1.

First, coal (fine particles), air, and char (not illustrated) are introduced into the combustion chamber 2a of the gasification furnace 2 and, after combustion thereof at a high temperature, additional coal (fine particles) is introduced into the gasification chamber 2b and the high-temperature combustion gas of the combustion chamber 2a is used to gasify the coal in the gasification chamber 2b. When this is done, coal gasification gas having hydrogen and carbon monoxide as its main components is generated from the gasification furnace 2. The coal gasification gas is sent from the gasification chamber 2b to the wet-process gas refining section 3a.

Next, at the wet-process gas refining section 3a, a desulfurizing method using MDEA as the adsorbing liquid is used to remove the hydrogen sulfide of the coal gasification gas. Then, the gas is sent from the wet-process gas refining section 3a to the dry-process desulfurizing section 3b.

Next, at the dry-process desulfurizing section 3b, hydrogen sulfide is adsorbed by microparticles of zinc oxide (ZnO), so as to remove the hydrogen sulfide from the gas. The gas is next sent from the dry-process desulfurizing section 3b to the shift reactor 4.

At the shift reactor 4, carbon monoxide and water are reacted by a CO shift reaction to generate carbon dioxide and hydrogen. Next, the gas that has been processed by the shift reaction is sent to the carbon dioxide scrubber 5.

At the carbon dioxide scrubber 5, an amine-based adsorbing liquid is used to cause adsorption of carbon dioxide present in the gas by the adsorbing liquid so as to remove the carbon dioxide. After removal of carbon dioxide, the gas is next sent from the carbon dioxide scrubber 5 to the denitrification apparatus 6.

At the denitrification apparatus 6, the molar ratio between nitrogen and hydrogen in the gas is adjusted to approximately 1:3 by removing nitrogen from the gas using a gas-separating membrane. After this adjustment, the gas is next sent from the denitrification apparatus 6 to the ammonia generator 7.

At the ammonia generator 7, the Haber-Bosch process is used to react the nitrogen and oxygen present in the gas so as to generate ammonia.

By the above-described processes, ammonia is generated from coal.

In this manner, the ammonia generating apparatus 1 according to this embodiment has a gasification furnace 2, into which coal and air are introduced, and which is constituted to gasify coal by performing partial oxidation, a desulfurizing apparatus 3 that is constituted so as to desulfurize the gas generated by the gasification furnace 2, a shift reactor 4 that is constituted to convert carbon monoxide present in the gas exhausted from the desulfurizing apparatus 3 to carbon dioxide, a carbon dioxide scrubber 5 that is constituted so as to remove carbon dioxide present in the gas that is exhausted from the shift reactor 4, a denitrification apparatus 6 that is constituted so as to adjust the molar ratio between nitrogen and hydrogen in the gas to approximately 1:3 by removing nitrogen from the gas exhausted from the carbon dioxide scrubber 6, and an ammonia generator 7 that generates ammonia by causing a reaction between nitrogen and hydrogen present in the gas exhausted from the denitrification apparatus 6.

According to the ammonia generating apparatus 1 of this embodiment, therefore, because air is used to perform gasification of coal in the gasification furnace 2, the oxygen concentration when the coal is combusted is reduced and, compared to the case of using oxygen to gasify coal, the temperature of the gasification reaction in the gasification furnace 2 is low. As a result, it is possible to extend the life of the refractory brick inside the gasification furnace 2. Also, because the temperature inside the gasification furnace 2 is low compared with the conventional art, there is no melting of ashes and the like generated in the processing of the coal and adhesion thereof to the walls of the gasification furnace 2, so that operation of the gasification furnace 2 is not hindered.

Also, according to the ammonia generating apparatus 1 of this embodiment, because gasification of coal is performed by blowing air, and it is possible to use the nitrogen present in the air in the subsequent generation of ammonia without the introduction of nitrogen into the gas as was conventionally done.

Additionally, although in the past oxygen was used to gasify coal, thereby necessitating oxygen generating plant equipment for supplying oxygen, with the present invention, because air is used to gasify coal, the need to provide oxygen generating plant equipment is eliminated, thereby enabling a reduction in the overall cost of the apparatus.

Also, according to the ammonia generating apparatus 1 of this embodiment, because the denitrification apparatus 6 is constituted so as to remove nitrogen by using a gas-separating membrane, it is possible to adjust the molar ratio between the nitrogen and the hydrogen by separation of the nitrogen and hydrogen, utilizing the difference in rate of permeation between nitrogen and hydrogen in the gas-separating membrane. Also, because the constitution uses a membrane, it is possible to achieve a simpler constitution for the apparatus. Also, in this constitution, because there is a reduction of the pressure of the nitrogen and the hydrogen that pass through the gas-separating membrane, it is necessary to raise the pressure when generating ammonia.

### Second Embodiment

The second embodiment of an ammonia generating apparatus according to the present invention is described below with reference to the accompanying drawings. FIG. 5 is a graph showing the adsorption equilibrium of hydrogen and nitrogen in activated charcoal.

In the second embodiment, the denitrification apparatus 6 is constituted to remove nitrogen by using an adsorbing material. Activated charcoal, MS5A (5 A molecular sieve), MA4A (4 A molecular sieve), or activated alumina or the like is used as the adsorbing material.

FIG. 5 shows the adsorption equilibrium of nitrogen and hydrogen in activated charcoal. As shown in FIG. 5, if hydrogen and nitrogen are compared, the amount of adsorption of hydrogen is higher. Therefore, if activated charcoal is used as an adsorbing material, it is possible to adjust the molar ratio between nitrogen and hydrogen using the difference in the adsorption amounts of nitrogen and hydrogen. In this embodiment, the denitrification apparatus 6 is constituted so as to adjust the molar ratio between nitrogen and hydrogen to approximately 1:3 by using the difference in the adsorption amounts of nitrogen and hydrogen, such as is shown in FIG. 5.

Because in the ammonia generating apparatus 1 according to this embodiment the denitrification apparatus 6 is constituted so as to remove nitrogen using an adsorbing material, it is possible to adjust the molar ratio between hydrogen and nitrogen by removing nitrogen from the gas, without reducing the pressure of hydrogen.

Although the above is a description of embodiments of the present invention, the present invention is not restricted to the described embodiments, and can be variously modified and take on various forms based on the technical concept of the present invention.

What is claimed is:

1. An ammonia generating apparatus comprising:
a gasification furnace into which coal and air are introduced, constituted so as to perform partial oxidation to gasify the coal;
a desulfurizing apparatus constituted so as to desulfurize the gas generated by the gasification furnace;
a shift reactor constituted so as to convert carbon monoxide present in the gas exhausted from the desulfurizing apparatus to carbon dioxide;
a carbon dioxide scrubber constituted so as to remove carbon dioxide present in the gas exhausted from the shift reactor,
a denitrification apparatus constituted so that, by removing nitrogen present in the gas exhausted from the carbon dioxide scrubber, the molar ratio between nitrogen and hydrogen present in the gas is adjusted to approximately 1:3; and
an ammonia generator that generates ammonia by causing a reaction between the nitrogen and hydrogen present in the gas exhausted from the denitrification apparatus.

2. The ammonia generating apparatus according to claim 1, wherein the denitrification apparatus is constituted to remove nitrogen by using a gas-separating membrane.

3. The ammonia generating apparatus according to claim 1, wherein the denitrification apparatus is constituted to remove nitrogen by using an adsorbing material.

4. An ammonia generating method including:
a step of gasifying coal by introducing coal and air and causing partial oxidation;
a step of desulfurizing the gas generated by the gasification step;
a step of converting carbon monoxide present in the gas to carbon dioxide;
a step of removing carbon dioxide present in the gas;
a step of adjusting the molar ratio between nitrogen and hydrogen present in the gas to approximately 1:3 by removing nitrogen present in the gas; and
a step of generating ammonia by causing a reaction between nitrogen and hydrogen present in the gas.

5. The ammonia generating method according to claim 4, wherein the adjusting step removes nitrogen by using a gas-separating membrane.

6. The ammonia generating method according to claim 4, wherein the adjusting step removes nitrogen by using an adsorbing material.
